(19) United States
(12) Patent Application Publication
(10) Pub. No.: US 2007/0160071 A1
(43) Pub. Date: Jul. 12, 2007

(54) Framework for a wireless communication device

(76) Inventors: Eric J. Overtoom, Grayslake, IL (US); Robin G. Adams, San Diego, CA (US)

Correspondence Address: INGRASSIA FISHER & LORENZ, P.C., 7150 E. CAMELBACK, STE. 325, SCOTTSDALE, AZ, 85251, US

(21) Appl. No.: 11/323,977

(22) Filed: Dec. 30, 2005

(51) Int. Cl. H04L 12/56; H04J 3/16

(52) U.S. Cl. 370/401; 370/466

(57) ABSTRACT

A method is provided for managing the operation of a wireless communication device. The method comprises receiving from a source a data stream incorporating at least some data in a generic format to be communicated via a wireless communications connection, determining a selected protocol interface module from a plurality of protocol interface modules, each of the plurality of protocol interface modules being adapted for formatting the data stream in at least one of a plurality of air-interface protocols, and establishing a data path between the source of the data stream and the selected protocol interface module.

### TECHNICAL FIELD

The present invention generally relates to communication systems, and more particularly relates to a communication architecture framework for wireless communication devices.

### BACKGROUND

Modern wireless communication systems utilize numerous air-interface protocols for sending various forms of data from wireless communication devices (e.g., a mobile or cellular telephones) to various wireless networks. Although each of these air-interfaces performs the same basic functions, such as call initiation and call termination, the actual protocols used by the air-interfaces differ greatly. Because the differences between particular protocols, such as Global System for Mobile communication (GSM), Universal Mobile Telecommunications System (UMTS) and North American Code Division Multiple Access (CDMA) are so great, it is sometimes impossible for the wireless communication devices that support multiple communication protocols to “re-use” applications between the different “stacks” for each of the protocols. Typically, each protocol requires a separate, unique implementation for protocol control, and the protocol stacks including the manner in which the applications communicate via a particular protocol are developed independently without accounting for how each of them interacts with other air-interface protocols.

The next generation of wireless communication devices will likely include “multi-mode phones” which incorporate two or more air-interface capabilities, such as various combinations of GSM, CDMA, and wireless local-area network (WLAN) capabilities. If such devices are not able to share any of the implementation details with respect to an air-interface protocol from single mode phones, the costs involved in manufacturing the multi-mode devices will be significantly increased. Additionally, there may be a need to add to the capabilities to the phone after being purchased by a retailer or a consumer, such as for the enabling of an accessory device. In current devices, the capabilities of the phones are largely designed into the device before the product is shipped. Any changes made to the capabilities can often require a sometimes significant firmware upgrade.

Additionally, such multi-mode phones will require a period of inter-mode operation as the phone switches between the different air-interfaces. However, if the user experiences any interruptions in service, the performance of the device will be unacceptable. It is possible that standards may eventually be developed that dictate how the phone manages interactions between two air-interface protocols with the assistance of the network, but until that time, there is a need for software to manage such interactions and be extremely flexible to accommodate such standards when they are developed.

Accordingly, it is desirable to not involve applications in protocol selection. In addition, it is desirable to have a separate component to determine which air-interface protocol should be used. Furthermore, other desirable features and characteristics of the present invention will become apparent from the subsequent detailed description and the appended claims, taken in conjunction with the accompanying drawings and the foregoing technical field and background.

### BRIEF SUMMARY

A method is provided for managing the operation of a wireless communication device. The method comprises receiving from a source a data stream incorporating at least some data in a generic format to be communicated via a wireless communications connection, determining a selected protocol interface module from a plurality of protocol interface modules, each of the plurality of protocol interface modules being adapted for formatting the data stream in at least one of a plurality of air-interface protocols, and establishing a data path between the source of the data stream and the selected protocol interface module.

An apparatus is provided for handling application data. The apparatus comprises an application interface, a telecommunication data source to transmit a data stream to the application interface, and first and second protocol interface modules in operable communication with the telecommunication information source through the application interface to receive the data stream such that the telecommunication data source has a common interface with the first and second protocol interface modules.

A device for wireless communication is provided. The device comprises an application interface, a telecommunication data source to transmit a data stream to the application interface, first and second protocol interface modules in operable communication with the telecommunication information source through the application interface to receive the data stream such that the telecommunication data source has a common interface with the first and second protocol interface modules, and a radio interface in operable communication with the first and second protocol interface modules, the radio interface comprising an antenna and at least one of a receiver and a transmitter.

### BRIEF DESCRIPTION OF THE DRAWINGS

The present invention will hereinafter be described in conjunction with the following drawing figures, wherein like numerals denote like elements, and

FIG. 1 is a block diagram of a wireless communication device;

FIG. 2 is a block diagram of a wireless communication device communication architecture according to one embodiment of the present invention;

FIG. 3 is a block diagram of wireless communication device communication architecture according to another embodiment of the present invention; and

FIG. 4 is a schematic view of a wireless communication environment including a plurality of wireless networks.

### DETAILED DESCRIPTION

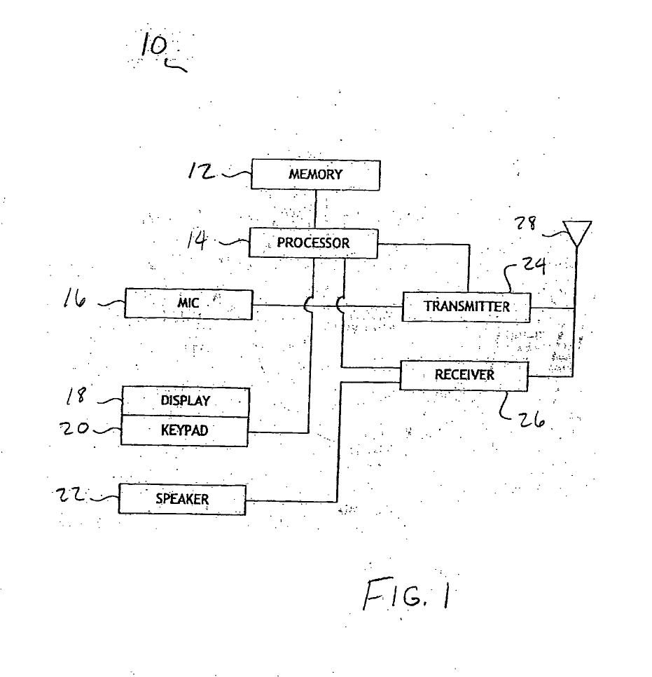

The following detailed description is merely exemplary in nature and is not intended to limit the invention or the application and uses of the invention. Furthermore, there is no intention to be bound by any expressed or implied theory presented in the preceding technical field, background, brief summary or the following detailed description. It should also be noted that FIGS. 1-4 are merely illustrative and may not be drawn to scale.

FIG. 1 to FIG. 4 illustrate a wireless communication device communication architecture system (e.g., framework or architecture). As will be described in greater detail below, the framework allows individual interface modules to be installed to handle the details of the air-interface protocols which the particular communications device (e.g., a mobile or cellular telephone) is capable of supporting. Additionally, selector modules are provided that handle the multi-mode interaction which may be required when the phone includes multiple interfaces. The selector modules route messages from a telecommunications data source within the telephones to the correct interface module based on, for example, the wireless networks that are currently available, cost information, operator configuration, or user preference. The multi-mode selector modules may also configure the way in which the framework routes messages.

FIG. 1 illustrates an exemplary wireless communications device 10 (e.g., cellular or mobile telephone). The telephone 10 includes a memory 12, a processor 14, a microphone 16, a display 18, a keypad 20, a speaker 22, a transmitter 24, a receiver 26, and an antenna 28. The microphone 16 converts a voice signal to an electrical signal which is transmitted by the transmitter 24 and radiated over the antenna 28. Signals received by the antenna 28 are received and demodulated by the receiver 26 before being converted to an audio signal by the speaker 22. A user input information and operates the telephone 10 using the keypad 20. The display 18 shows the user what was input on the keypad 20 as well as information that was received by the receiver 26. As is commonly understood, the transmitter 24, the receiver 26, and the antenna 28 may jointly form a radio interface for the telephone 10.

The processor 14 is in operable communication with the memory 12 and controls the telephone 10 by scanning the keypad 20 for inputs, displaying appropriate data on the display 18, and controlling the transmission and reception of the data. Further, the processor 14 performs the computation and control functions of the system described below and may comprise any type of processor, include single integrated circuits such as a microprocessor, or may comprise any suitable number of integrated circuit devices and/or circuit boards working in cooperation to accomplish the functions of a processing unit. In addition, processor 14 may comprise multiple processors implemented on separate computer systems, such as a system where a first processor resides on a target computer system designed to closely resemble the final hardware system and a second processor resides on a test computer system coupled to the target hardware system for testing. During operation, the processor 14 executes one or more sets of prestored instructions on the memory 12 and controls the general operation of the system described below.

The memory 12 can be any type of suitable memory. This would include the various types of dynamic random access memory (DRAM) such as SDRAM, the various types of static RAM (SRAM), and the various types of non-volatile memory (PROM, EPROM, and flash). It should be understood that memory 12 may be a single type of memory component, or it may be composed of many different types of memory components. In addition, the memory 12 and the processor 12 may be distributed across several different computers (e.g., devices).

It should also be understood that while the present invention is described in the context of a fully functioning computer system (e.g. a wireless communications device), those skilled in the art will recognize that the some aspects of the present invention are capable of being distributed as a program product in a variety of forms, and that the present invention applies equally regardless of the particular type of signal bearing media used to carry out the distribution. Examples of signal bearing media include: recordable media such as floppy disks, hard drives, memory cards and optical disks, and transmission media such as digital and analog communication links.

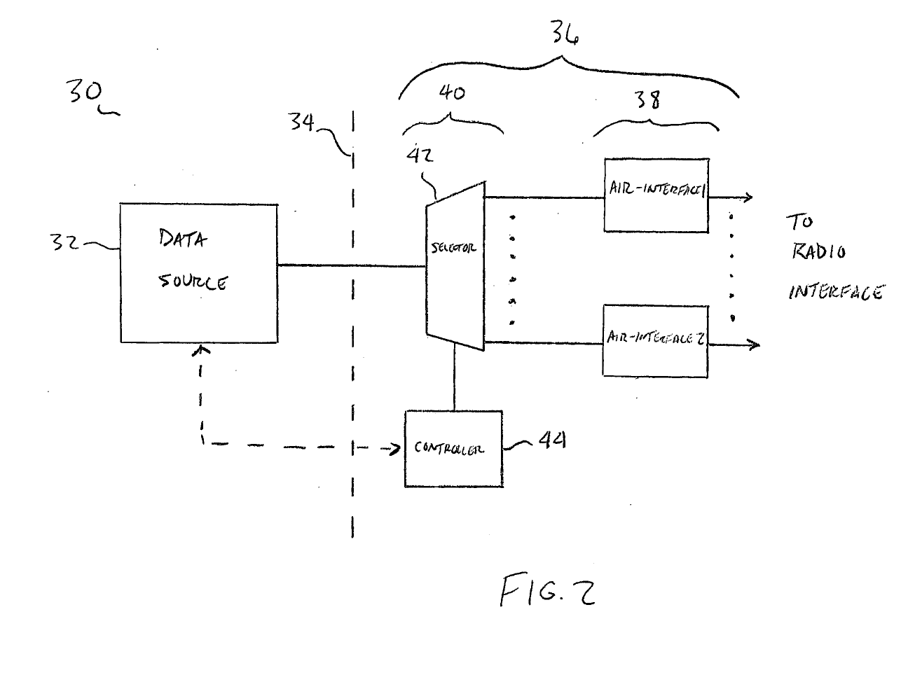

FIG. 2 illustrates a communication architecture framework 30, according to one embodiment of the present invention, which is stored on the memory 12 and executed by the processor 14 within the wireless communication device 10 shown in FIG. 1. The framework 30 includes a telecommunications data source 32 (e.g., an application), a data interface 34, and a plurality of protocol interface modules 36. The telecommunications data source 32 may include, for example, a voice communication application, a text messaging application, an email application, a data communications application, or a “push-to-X” application.

The data interface 34, or application interface, as will be appreciated by one skilled in the art, is a set of definitions which dictates how the application 32 interacts and communicates with the modules 36. In one embodiment, the data interface 34 incorporates a standard or generic data format for accommodating a uniform construct for conveying similar types of data. The data interface may be an application programming interface (API). The protocol interface modules 36 include air-interface protocol modules 38 and controller modules 40.

As shown, the data source 32 is in operable communication with the data interface 34 and the protocol interface modules 36 through the data interface 34, and vice versa. It should be noted that the data source 32 thus has a single interface with the protocol interface modules 36. Additionally, the protocol interface modules 36 are coupled to components of the radio interface illustrated in FIG. 1.

Although not specifically illustrated, the air-interface protocol modules 38 each include a respective air-interface protocol stack such that the air-interface protocol modules 38 are capable of receiving a generic data stream and converting the data stream into a format compatible with, or specific to, its respective air-interface protocol. The air-interface protocols may include Code Division Multiple Access (CDMA), Time Division Multiple Access (TDMA), Global System for Mobile communication (GSM), Integrated Digital Enhanced Network (iDEN), Cellular Digital Packet Data (CDPD), Personal Digital Communications (PDC), Personal Handyphone System (PHS), General Packet Radio System (GPRS), Enhanced Data Rates for Global Evolution (EDGE), Single Carrier Radion Transmission Technology (1xRTT), i-Mode, High Speed Circuit Switched Data (HSCSD), Short Message Service (SMS), Transmission Control Protocol/Internet Protocol (TCP/IP), Wireless Application Protocol (WAP), General Packet Radio Service (GPRS), Push Access Protocol (PAP), Session Initiation Protocol (SIP), and Universal Mobile Telecommunications System (UMTS).

As shown, the controller modules 40 include, in the depicted embodiment, a selector, or router, module 42 and an interface controller module 44. The selector module 42 is capable of establishing a data path between the telecommunications data source 32 and each of the air-interface protocol modules 38, while the interface controller module 44 is coupled to the data source 32, the air-interface protocol module 38, and the selector module 42. Although illustrated as separate modules, it should be understood that the selector 42 and interface controller 44 may be contained within a single module.

In use, the telecommunications data source 32 transmits a data stream, or message, through the interface 34 to the selector module 42. The interface controller module 44 then determines which air-interface protocol should be utilized for the data stream. The determination may be based on, for example, wireless networks that are currently available for use by the telephone, a prioritization scheme of the different air-interface protocols, as well as the corresponding wireless networks, and/or a preference indicated by the data source. The interface controller module 44 then sends a control signal to the selector module 42 indicating which air-interface is to be used. In one embodiment, the data steam, as sent from the data source 32, is in a “generic” format and does not include any indication of which air-interface is to be used during transmission.

The selector module 42, based on the control signal from the interface controller module 44, routes the data stream to one of the air-interface protocol modules 38. In this way, the selector module 42 establishes a data path between the data source 32 and the selected air-interface protocol module. The selected air-interface protocol module receives the data stream and converts the data stream from the generic format as sent from the data source into a format compatible with the air-interface protocol associated with the selected air-interface protocol module. The formatted data stream is then sent to the radio interface of the telephone 10 where it is communicated wirelessly to the appropriate network via the antenna 28.

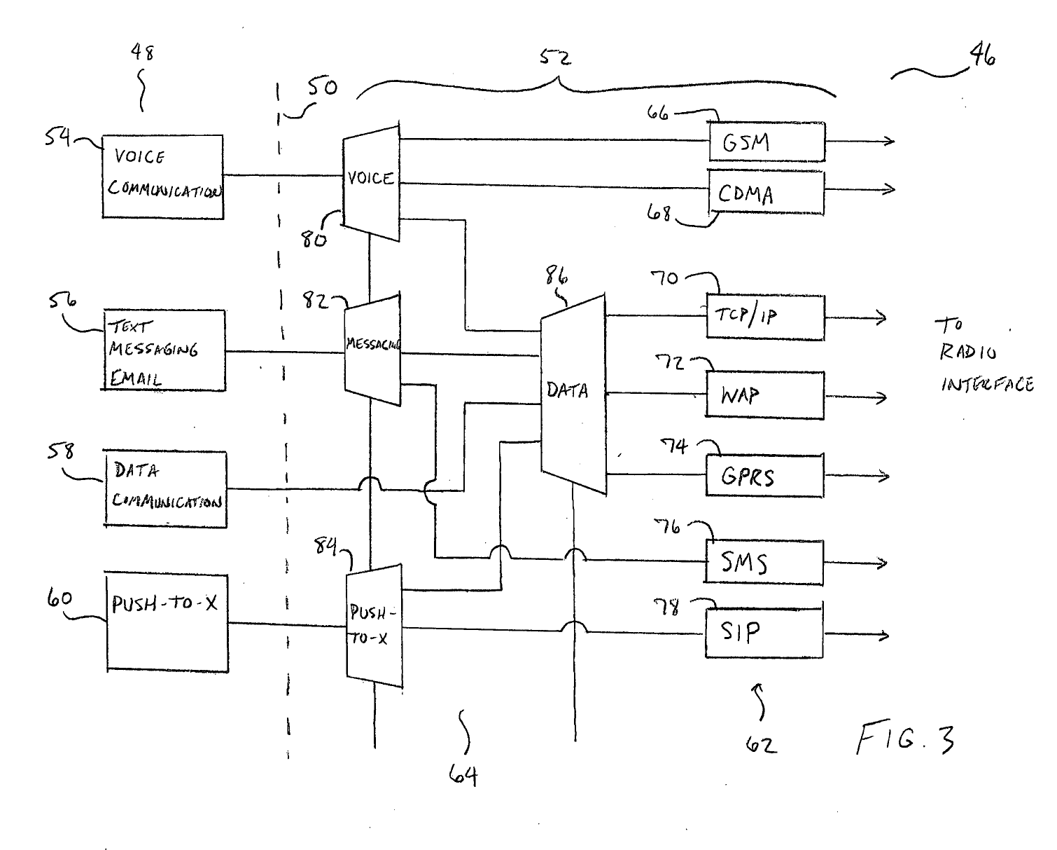

FIG. 3 illustrates a telephony communication architecture framework 46 according to another embodiment of the present invention. The framework 46 includes a plurality of telecommunications data sources 48 (i.e., applications), a data interface 50, and a plurality of protocol interface modules 52. Similarly to the framework 30 illustrated in FIG. 2, the data sources 48 are in operable communication with the protocol interface modules 52, and vice versa, though the data interface 50. The data sources 48 include a voice communication application 54, a text messaging/email application 56, a data communication application 58, and a push-to-X application 60 (e.g., push-to-talk) application.

In the embodiment illustrated in FIG. 3, the protocol interface modules 52 include a plurality of air-interface protocol modules 62 and a plurality of controller modules 64. The air-interface protocol modules 62 include individual modules 66-78 respectively for each of the GSM, CDMA, TCP/IP, WAP, GPRS, SMS, and SIP protocols. The controller modules 64 include a voice controller module 80, a messaging controller module 82, a push-to-X controller module 84, and a data controller module 86. The various controller modules 64 are coupled to at least one of the applications 48, with the data controller module 86 being coupled to multiple applications 48. Additionally, the voice 80, messaging 82, push-to-X 84, and data controller module 86 are coupled to multiple air-interface protocol modules 62.

In use, similarly to the framework 30 illustrated in FIG. 2, the applications 48 send data streams (i.e., messages) through the data interface 50 to the various controller modules 64. As will be appreciated by one skilled in the art, a particular message from a particular application may include two types of information. For example, a voice message from the voice communication application 54 may include both voice information and data information.

The controller modules 64 receive control signals, similar to those described above, which include a determination of which of the available air-interface protocols should be used for the transmission of the current message. This determination may again be based on, for example, the wireless networks that are currently available for use by the telephone, a prioritization scheme of different air-interface protocols, as well as the corresponding wireless networks, and/or a preference indicated by the data source. As a message may include multiple types of data, the controller modules 64 may be configured to manage the routing of messages for several air-interface protocols. For example, the voice controller module 80 may route the voice portion of the message to the GSM air-interface protocol module 66 and route the data portion of the message to the data controller module 86, which in turn routes the data portion to the TCP/IP air-interface protocol module 70.

If the controller modules 64 receive a control signal to send a message to an air-interface protocol that is associated with a type of wireless network that is not currently available, the message, or at least a portion of the message, may be “dropped.” If an appropriate wireless network is available, after being formatted in the respective air-interface protocol by the appropriate protocol interface module 52, the message is sent to the radio interface of the telephone 10 where it is wirelessly transmitted to the appropriate wireless network.

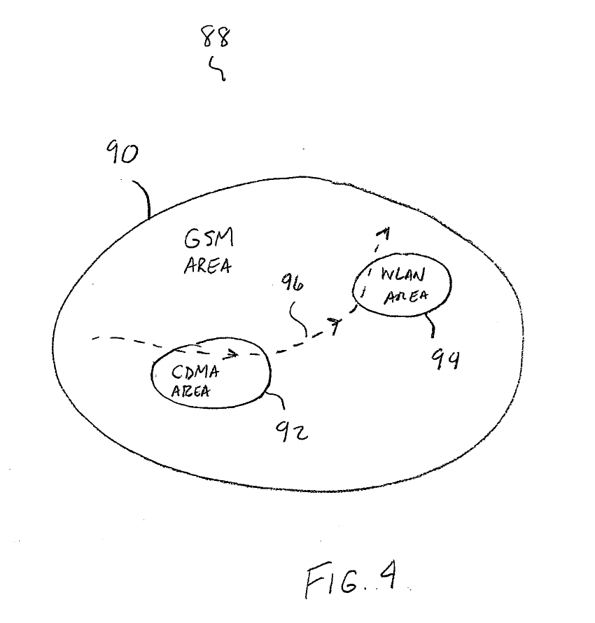

FIG. 4 illustrates a wireless communications environment 88 including first 90, second 92, and third 94 coverage areas for respective first, second, and third wireless networks. As shown, the first coverage area 90 encompasses the second and third coverage areas 92 and 94. Each of the first 90, second 92, and third 94 wireless networks may be compatible with at least one of the air-interface protocols mentioned above.

As will be appreciated by one skilled in the art, as a wireless communications device, such as the telephone 10 illustrated in FIG. 1, moves through the coverage areas, the wireless communications device 10 is able to detect that such a wireless network is available. For example, if the first network 90 is a GSM network, the GSM network would be detected and available to the wireless communications device while positioned within the first coverage area 90. If the first and second networks were CDMA and WLAN networks, such networks, in addition to the first network, would be detected and available to the device while positioned within the second and third coverage areas 92 and 94, respectively.

As such, as the device moves through the wireless communications environment along a particular path 96, different wireless networks become available. As previously mentioned, the availability of the various networks may be used in the determination of which of the air-interface protocols should used for the transmission of a particular message, or portion of a message.

One advantage of the wireless communication device communication architecture framework described above is that the various implementation details which are specific to particular air-interfaces protocols are encapsulated and may be added to a particular framework within minimal modification to the remainder of the framework. Additionally, because the protocol interfaces are separated from each other and the air-interface operation is separate from the multi-interface operation and selection rules, necessary changes to one will have minimal effects on the other. Another advantage is that because any changes are largely localized, changes in one part of the framework will minimally impart the other portions of the framework. Consequently, to the extent that changes to the protocol stacks can be minimized, the quality of the interface will be allowed to stabilize and presumably be optimized across different implementations of the framework. The framework is simplified because only a single version of the stack and stack interface are needed. Furthermore, because the applications have a single, consistent, and generic interface with the various modules, applications which can support multiple air-interface protocols (i.e., protocol-independent applications) may be more easily developed. As a result, fewer versions of the applications to handle different protocols are required.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for managing the operation of a wireless communication device comprising:
receiving from a source a data stream incorporating at least some data in a generic format to be communicated via a wireless communications connection;
determining a selected protocol interface module from a plurality of protocol interface modules, each of the plurality of protocol interface modules being adapted for formatting the data stream in at least one of a plurality of air-interface protocols; and
establishing a data path between the source of the data stream and the selected protocol interface module.

2. The method of claim 1, further comprising converting by the selected protocol interface module the received data stream to a form compatible with at least one of the air-interface protocols.

3. The method of claim 2, further comprising communicating wirelessly via a radio interface the converted data stream produced by the selected protocol interface.

4. The method of claim 3, wherein the converted data stream includes at least one of information and formatting, the formatting originating in the selected protocol interface module.

5. The method of claim 4, wherein said determination of the selected protocol interface module is based on the availability of each of a plurality of wireless networks.

6. The method of claim 4, wherein said determination of the selected protocol interface module is based on a prioritization of the plurality of protocol interface modules.

7. The method of claim 4, wherein the determination of the selected protocol interface module is based on a preference indicated by the source.

8. The method of claim 4, wherein the source comprises at least one of a voice communication application, a text messaging application, an email application, a data communications application, and a push-to-X application.

9. The method of claim 8, wherein the plurality of air-interface protocols comprises at least one of Code Division Multiple Access (CDMA), Time Division Multiple Access (TDMA), Global System for Mobile communication (GSM), Integrated Digital Enhanced Network (iDEN), Cellular Digital Packet Data (CDPD), Personal Digital Communications (PDC), Personal Handyphone System (PHS), General Packet Radio System (GPRS), Enhanced Data Rates for Global Evolution (EDGE), Single Carrier Radion Transmission Technology (1xRTT), i-Mode, High Speed Circuit Switched Data (HSCSD), Short Message Service (SMS), Transmission Control Protocol/Internet Protocol (TCP/IP), Wireless Application Protocol (WAP), General Packet Radio Service (GPRS), Push Access Protocol (PAP), Session Initiation Protocol (SIP), and Universal Mobile Telecommunications System (UMTS).

10. The method of 9, wherein said steps of receiving the data stream, determining the selected protocol interface, and establishing the data path include one or more sets of prestored instructions on a computer readable medium.

11. An application data handler comprising:
an application interface;
a telecommunication data source to transmit a data stream to the application interface; and
first and second protocol interface modules in operable communication with the telecommunication information source through the application interface to receive the data stream such that the telecommunication data source has a common interface with the first and second protocol interface modules.

12. The application data handler of claim 11, wherein the first and second protocol interface modules respective comprise first and second air-interface protocol stacks.

13. The application data handler of claim 12, further comprising a third protocol interface module in operable communication with the telecommunication data source, the first protocol interface module, and the second protocol interface module through the application interface to determine a selected protocol interface module from the first and second protocol interface modules.

14. The application data handler of claim 13, wherein the third protocol interface module is further to route the data stream from the telecommunication data source to the selected protocol interface module.

15. The application data handler of claim 14, wherein the selected protocol interface module is to convert the data stream to a form compatible with at least one of the first and second air-interface protocols.

16. The application data handler of claim 15, wherein the telecommunication data source comprises at least one of a voice communication application, a text messaging application, an email application, a data communications application, and a push-to-X application.

17. A wireless communication device comprising:
an application interface;
a telecommunication data source to transmit a data stream to the application interface;
first and second protocol interface modules in operable communication with the telecommunication information source through the application interface to receive the data stream such that the telecommunication data source has a common interface with the first and second protocol interface modules; and
a radio interface in operable communication with the first and second protocol interface modules, the radio interface comprising an antenna and at least one of a receiver and a transmitter.

18. The wireless telecommunication device of claim 17, wherein the first and second protocol interface modules respective comprise first and second air-interface protocol stacks.

19. The wireless telecommunication device of claim 18, wherein the telecommunication data source comprises at least one of a voice communication application, a text messaging application, an email application, a data communications application, and a push-to-X application.

20. The wireless telecommunication device of claim 19, wherein the first and second air-interface protocol stacks correspond to respective first and second air-interface protocols, the first and second air-interface protocols comprising at least one of Code Division Multiple Access (CDMA), Time Division Multiple Access (TDMA), Global System for Mobile communication (GSM), Integrated Digital Enhanced Network (iDEN), Cellular Digital Packet Data (CDPD), Personal Digital Communications (PDC), Personal Handyphone System (PHS), General Packet Radio System (GPRS), Enhanced Data Rates for Global Evolution (EDGE), Single Carrier Radion Transmission Technology (1xRTT), i-Mode, High Speed Circuit Switched Data (HSCSD), Short Message Service (SMS), Transmission Control Protocol/Internet Protocol (TCP/IP), Wireless Application Protocol (WAP), General Packet Radio Service (GPRS), Push Access Protocol (PAP), Session Initiation Protocol (SIP), and Universal Mobile Telecommunications System (UMTS).
